(19) United States
(12) Patent Application Publication
(10) Pub. No.: US 2022/0363577 A1
(43) Pub. Date: Nov. 17, 2022

(54) METHOD AND APPARATUS FOR TREATMENT OF WASTEWATER CONTAINING AZIDE IONS

(71) Applicant: VWS (UK) Limited, Buckinghamshire (GB)

(72) Inventors: Lee Underwood, Buckinghamshire (GB); John Walker, Berkshire (GB); James Keary, Buckinghamshire (GB)

(73) Assignee: VWS (UK) Limited, Buckinghamshire (GB)

(21) Appl. No.: 17/634,106

(22) PCT Filed: Aug. 27, 2020
(86) PCT No.: PCT/GB2020/052046

§ 371 Date: Feb. 9, 2022

(30) Foreign Application Priority Data
Sep. 13, 2019 (GB) 1913242.2

(51) Int. Cl. C02F 9/00

(52) U.S. Cl. CPC C02F 9/00; C02F 2301/046; C02F 1/4672

(57) ABSTRACT

Disclosed is a method of treating a clinical analyser wastewater stream containing a first concentration of azide ions in solution, comprising at least the step of passing the clinical analyser wastewater stream through an anodic oxidation chamber having one or more anodic oxidation cells to provide a post-chamber treated water stream, said treated water stream having a second concentration of azide ions in solution that is less than the first concentration of azide ions in solution. A clinical analyser treatment apparatus comprising an anodic oxidation chamber having one or more anodic oxidation cells able to reduce a concentration of azide ions is also disclosed.

The present invention relates to a method for treating wastewater containing azide ions, particularly but not exclusively wastewater from clinical analysers.

The azide ion is an anion of formula N₃⁻. Its salts are very soluble in water and it is very toxic. It has been used in airbags due to its decomposition on heating to produce nitrogen which rapidly inflates the airbags. Its salts can also be ‘shock sensitive’. This instability has caused dangerous spontaneous explosions when allowed to build up in drains, and then suddenly released.

However, azide compounds such as sodium azide are also commonly used as a biocide in a number of reagent chemicals and other solutions at concentrations of up to 0.1%. It binds to cytochrome oxidase of gram-negative bacteria, inhibiting the protein from functioning, leading to chemical asphyxiation of the cell. Azide compounds may also be used as a chemical probe to react with proteins and identify their presence. In this way an azide ion may be used to form azide methhaemoglobin during analysis of blood in clinical analysers. Azide ions may therefore be present in analyser wastewater streams due to its use as a biocide or as a chemical probe, and should be removed if the wastewater is to be passed to municipal sewers.

Azides are usually decomposed by treatment with chemicals, typically nitrous acid. As this is a specialist process, there is the need for accumulation, storage and collection from site by specialist contractors so that the waste may be disposed of safely.

U.S. Pat. No. 6,024,860 discloses a system for electrochemical decomposition of 2% sodium azide from waste from automobile airbag manufacture using an electrolyser with either nickel or graphite anodes, and with resulting ammonia recovered in water.

Clinical analysers are well known in the art, generally being medical laboratory instruments able to analyse a sample, generally a medical sample, to determine one or more characteristics in or for a clinical purpose. One example is an analyser able to measure the properties of bodily fluids such as blood or urine, to assist in diagnosis of a condition or disease of a patient. To enable such determination, the analyser uses various known reagent chemicals which are provided by the analyser manufacturer.

Clinical analysers are used to process a large portion of the samples going into a hospital or private medical laboratory. In the US, such apparatus are regulated under the Code of Federal Regulations (CFR) Title 21, in particular Part 862. Section 862.2150 defines a continuous flow sequential multiple chemistry analyser for clinical use.

Clinical analysers generally use one or more water streams, often of purified or indeed ultra-purified water, in the processing and analysis of samples, and/or for cleaning of reaction vessels, tubing and sample holders, etc. The or each resultant water stream or streams, or ‘effluent(s)’, after such use is or are termed the ‘wastewater’. Where there are multiple resultant streams, each stream can be dealt with separately, but are usually combined together to form a single wastewater stream. Due to the use of alkaline solutions, such as sodium hydroxide in the processes of the analyser, the wastewater is typically of high pH.

With increasing health and safety legislation and increased local regulation, clinical analyser wastewater is increasingly unable to be simply discharged to the municipal drain, but must instead be collected for off-site disposal or treatment, or is increasingly required to be treated on site.

It is an object of the present invention to provide an improved method and apparatus for the treatment of clinical analyser wastewater containing one or more azide compounds or azide ions.

Thus according to one aspect of the present invention, there is provided a method of treating a clinical analyser wastewater stream containing a first concentration of azide ions in solution, comprising at least the step of:
passing the clinical analyser wastewater stream through an anodic oxidation chamber having one or more anodic oxidation cells to provide a post-chamber treated water stream, said post-chamber treated water stream having a second concentration of azide ions in solution that is less than the first concentration of azide ions in solution.

The reduction, optionally the removal, of azide ions, assists downstream processing of the water stream and reduces the risk of an azide explosion due to accidental build up in a downstream locale such as a drain.

The anodic oxidation chamber may comprise any number of anodic oxidation cells, which cells may be separate, shared or overlap, or a combination of same. Each cell may be a distinct entity, or may be a definable area within a chamber associated with electrodes to achieve anodic oxidation. The or each anodic oxidation cell comprises at least two electrodes, generally at least one anode and one cathode. Electrodes may also be shared or overlap between more than one anodic oxidation cells.

Optionally, the anodic oxidation chamber comprises an anodic oxidation cell, comprising two electrodes, being an anode and a cathode.

Optionally, the anodic oxidation chamber has an anodic oxidation cell having an anode, and said anode includes boron doped diamond.

Optionally, the clinical analyser wastewater stream further has a first concentration of one or more organic molecules, and after passing through the through the anodic oxidation chamber according to the present invention, the treated water stream has a second concentration of the same one or more organic molecules less than the first concentration of one or more organic molecules.

Optionally, the clinical analyser wastewater stream further has a first total concentration of one or more organic molecules, and after passing through the anodic oxidation chamber according to the present invention, the treated water stream has a second total concentration of the same one or more organic molecules less than the first total concentration of one or more organic molecules.

Optionally, all or part of the treated water stream is recirculated through the anodic oxidation cell and re-treated.

Optionally, the second concentration of azide in the treated water stream is less than 100 ppb.

Optionally, the anodic oxidation chamber is part of a wastewater treatment apparatus.

Optionally, the method of the present invention further comprises the step of venting any gases generated by the anodic oxidation chamber. Such venting may be passive or positive, i.e. involving a pressure change such as suction to assist gas movement. Optionally, the venting of generated gases comprises at least the steps of venting and diluting said gases from the anodic oxidation chamber. Typically, such gases are then vented or exhausted to atmosphere or to a suitable gas capturing means. Such gases include expected products from the anodic oxidation, such as various nitrogen-species, and possibly hydrogen produced at the electrode(s), whose concentration or build up is not desired for obvious reasons. Dilution assists reducing any such concentration prior to venting or exhausting, and may be provided by any suitable gas extraction apparatus, device or system known in the art.

Optionally, the method of the present invention further comprises the step of treating the clinical analyser wastewater stream with UV irradiation.

Optionally, the method of the present invention further comprises the step of filtering the clinical analyser wastewater stream.

Optionally, the method of the present invention further comprises the step of adjusting the pH of the clinical analyser wastewater stream.

Optionally, the method comprises at least the steps of:
passing the clinical analyser wastewater stream through an anodic oxidation chamber having one or more cells to provide a post-chamber treated water stream, said treated water stream having a second concentration of azide ions in solution that is less than the first concentration of azide ions in solution;
venting and diluting any gases generated by the anodic oxidation chamber;
treating the clinical analyser wastewater stream with UV irradiation;
filtering the clinical analyser wastewater stream; and
adjusting the pH of the clinical analyser wastewater stream.

According to another aspect of the present invention, there is provided a clinical analyser treatment apparatus for treating a clinical analyser wastewater stream, comprising an anodic oxidation chamber having one or more anodic oxidation cells able to reduce the concentration of azide ions in the wastewater stream.

Optionally, the clinical analyser treatment apparatus is able to reduce the concentration of azide ions in the wastewater stream to less than 100 ppb.

Optionally, the clinical analyser treatment apparatus further comprises an anodic oxidation chamber able to reduce the total concentration of organic molecules in the wastewater stream.

The term “clinical analyser” as used herein relates to any apparatus, unit or instrument able to analyse a clinical, medical or biological sample, usually in an automated manner, and commonly in a multiple batch process, in order to measure or define one or more characteristics of or within the sample, such as the presence and/or amount of certain chemical or biological substances, such as particular markers or cells or the like. Suitable examples include the analysis of blood or other bodily fluids. In the US, such clinical analysers can be defined under CFR21 Part 862.

The term “wastewater” as used herein relates to one or more of the discharges or effluents from a clinical analyser which include one or more substances not considered environmentally safe for direct discharge into a drain or other non-clinical water system. Such substances include, but are not limited to, ions including azide ions, organics, biochemical reagents, heavy metals, heavy metal complexes, inorganic salts, inorganic reagents, and any other chemically or biologically active bodies.

The treatment apparatus of the present invention comprises at least one inlet, optionally a plurality of inlets, optionally for receiving water from a number of waste outlets from a clinical analyser or from multiple clinical analysers.

Similarly, the treatment apparatus of the present invention comprises at least one treated water outlet, optionally a plurality of treated water outlets. Optionally, at least one outlet of the treatment apparatus provides a discharge, line or passage to a drain, preferably a non-dedicated drain within the environment of the clinical analyser.

In environmental chemistry, the chemical oxygen demand (COD) test is commonly used to indirectly measure the amount of organic molecules in a fluid such as water: for example, the amount of organic pollutants in a water stream or sample. It is expressed in milligrams per litre (i.e. mg/L, or mg/L as O₂), indicating the mass of oxygen consumed per litre of solution, and the test is based on ISO 6060. Many governments now have strict regulations regarding the maximum COD allowed in wastewater before it can be discharged to municipal sewers.

Similar considerations and measurements can be considered for the biological oxygen demand (BOD) of a stream.

The term “anodic oxidation” as used herein relates to the action that can be provided by an electrochemical cell in a chamber comprising one or more anodes and one or more cathodes. A fluid path from an inlet into the chamber allows the wastewater to flow between the electrodes to an outlet of the chamber. A potential is induced between the electrodes causing a current to flow through the wastewater, attracting cations to the cathode and anions to the anode. The reactions at the anode result in oxidation of the ions in the wastewater. The choice of anode material is important in deciding which reactions at the anode occur.

According to one embodiment of the present invention, the or one anodic oxidation cell includes a conductive diamond anode. Such an electrode has a core material or base electrode substrate, able to support on its outer (active) surface a diamond material. Several methods are known for depositing diamond material on an electrode substrate, including CVD and PVD processes, to provide a diamond film or coating, generally comprising fine diamond particles as a thin final layer. Generally, the diamond is provided as a synthetic diamond obtained by reducing one or more suitable organic molecules in a manner known in the art.

Preferably, the conductive diamond anode is a boron doped diamond electrode, wherein a small amount of a boron ‘impurity’ is included in the diamond material and/or final diamond layer. Boron doped diamond electrodes are tough and resistant to degradation, as well as being chemically stable, resistant to thermal shock and able to exhibit high electrochemical stability. Such electrodes do not interact or bind to organic pollutants but can provide direct anodic oxidation to a water stream by the stripping of electrons from the covalent bonds of polluting substances. Such electrodes can be made by polycrystalline diamond formed by chemical vapour deposition (CVD) in a high temperature process.

Thus, the treatment apparatus and method of the present invention preferably further comprise passing the wastewater, generally as a stream, through an anodic oxidation chamber having an anodic oxidation cell including a conductive diamond anode, preferably a boron doped diamond electrode, to oxidise the organic molecules and azide ions in the stream, and to reduce the organic molecule and azide ion concentrations such that the concentration of organic molecules and azide ions in the post-chamber treated water stream is less than the concentration of organic molecules and azide ions in the wastewater entering the chamber.

Preferably the anodic oxidation chamber is part of an anodic oxidation subsystem, the subsystem being part of the wastewater treatment apparatus. Preferably the anodic oxidation subsystem includes means for recirculating the wastewater through the anodic oxidation chamber to increase the oxidation action on the azide ions and organic molecules within the wastewater. The recirculation may be of part of the stream exiting the anodic oxidation chamber with the remainder passing from the anodic oxidation subsystem, or all of the stream may be recirculated for a period and then flushed from the subsystem in a batch operation, or a combination of complete and partial recycle routines may be operated, such that complete recirculation is used when inlet azide ions and/or organic molecule concentration is high and partial recirculation is used when inlet azide ions and/or organic concentration is low or has been reduced by the anodic oxidation chamber.

One or more sensors can be used to determine the azide ions and/or organic molecule concentration in the feedwater to the anodic oxidation chamber and/or the treated water stream from the anodic oxidation chamber. These may be direct sensor measurements of one or more concentrations, or may be indicative sensor measurements, such as the conductivity or pH of the streams from which the concentrations of the azide ion and/or organic molecules may be deduced or measurements of the amount or content of gases produced.

Preferably the concentration of azide ion in the treated water stream leaving the anodic oxidation chamber is reduced to less than 100 ppb, or less than detectable.

The wastewater treatment apparatus may contain several other purification technologies in discrete or combined combinations or subsystems.

Optionally the wastewater treatment apparatus contains an ultra-violet (UV) sanitisation subsystem able to destroy any microbiologically active components in the wastewater. The provision of UV light is known in the art and may be provided by any known method such UV tubes, lamps or light emitting diodes (LEDs), with the light shining into a tube or container through which the water to be purified is passed.

Optionally the wastewater treatment apparatus contains a particle and heavy metal removal subsystem. The particle and heavy metal removal section contains material able to remove particles and/or heavy metals in particular heavy metal ions from the water passing through the particle and heavy metal removal subsystem. Suitable materials include foams, resins, adsorbents, and activated carbon. These materials may be treated to increase their affinity for the materials to be removed.

Preferably the wastewater treatment apparatus contains a pH adjustment subsystem able to adjust the pH before the treated water is passed from the wastewater treatment apparatus. This may include ion exchange material such as weak acid cation ion exchange resin that exchanges ions in the water passing through the subsystem with ions from the resin. An alternative method is shown in EP2765118 where carbon dioxide is used to adjust the pH.

Optionally, the clinical analyser treatment apparatus comprises an anodic oxidation subsystem, a UV disinfection subsystem, a filtration subsystem and a pH adjustment subsystem.

Optionally, a clinical analyser wastewater stream to be processed by the present invention passes sequentially through the anodic oxidation subsystem, UV disinfection subsystem, filtration subsystem and pH adjustment subsystem.

Operation of the wastewater treatment apparatus may involve recirculation of the water from or exiting any of the subsystems to or before an upstream subsystem for re-treating. This may be initiated by readings from sensors, water levels in sections or on a time basis.

The wastewater treatment apparatus may be constructed within a single housing or chassis containing at least the anodic oxidation chamber, and optionally also including other wastewater treatment method steps, subsystems, process controllers, valves, pumps, sensors, tubes, conduits, and reservoirs.

The action of oxidation of the wastewater results in the production of gases such as ammonia from at least the azide ions, and also potentially from nitrogen containing organic molecules. Ammonia may be harmful in elevated concentrations to operators in the vicinity of the wastewater purification device and it is important that these are reduced in concentration to or maintained at safe concentrations when discharged into the local atmosphere.

Bodies such as the UK Health and Safety Executive (HSE) set exposure limits for various substances and for ammonia the HSE sets a long term (8 hour) exposure limit of 25 ppm and a short term exposure limit of 35 ppm. It is therefore important that locations both within the wastewater treatment apparatus where gases could accumulate, and in the vicinity of the apparatus, are maintained with concentrations of ammonia and any other gases generated within the apparatus below the exposure limits. The wastewater treatment apparatus will typically be operated in a laboratory with normal laboratory ventilation. The minimum amount of ventilation is also specified by various national bodies such as found in German DIN 1946-7 and the American Society of Heating, Refrigeration and Air-Conditioning Engineers Handbook.

Optionally, the wastewater treatment apparatus includes a gas extraction subsystem. The gas extraction subsystem is able to vent, optionally vent and dilute, any gases generated by the anodic oxidation chamber. Typically, such gases are then vented or exhausted to atmosphere or to a suitable gas capturing means either as part of the gas extraction subsystem or subsequent thereto. Dilution can be provided by a suitable dilutor.

Venting, dilution and gas extraction apparatus, devices or systems are known in the art. They include means for extracting the gases from the headspace above any subsystem described herein that may generate hazardous gases, either individually or combined. Preferably such gases are diluted by air taken from outside the wastewater treatment apparatus, and then exhausted or passed outside the water treatment apparatus at such concentrations that will not be a hazard to operators.

Preferably the air from outside the apparatus is blown by a fan or pumped using an air pump through a conduit including an ejector or eductor. The suction from the ejector or eductor is connected via a suitable conduit to the headspace above the water treatment subsystems and the gas within the headspace is removed via the ejector or eductor.

Embodiments of the present invention will now be described by way of example only and with reference to the accompanying drawings in which:

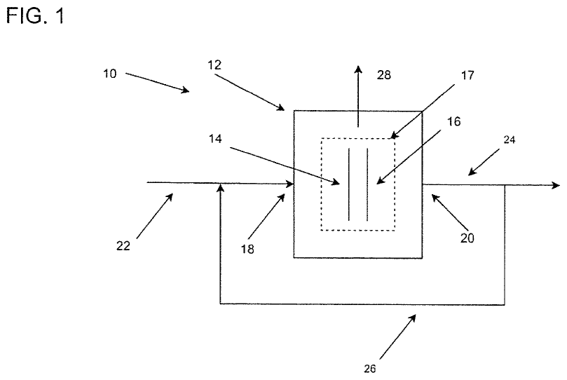

FIG. 1 shows an anodic oxidation chamber and a method of treating according to an embodiment of the present invention;

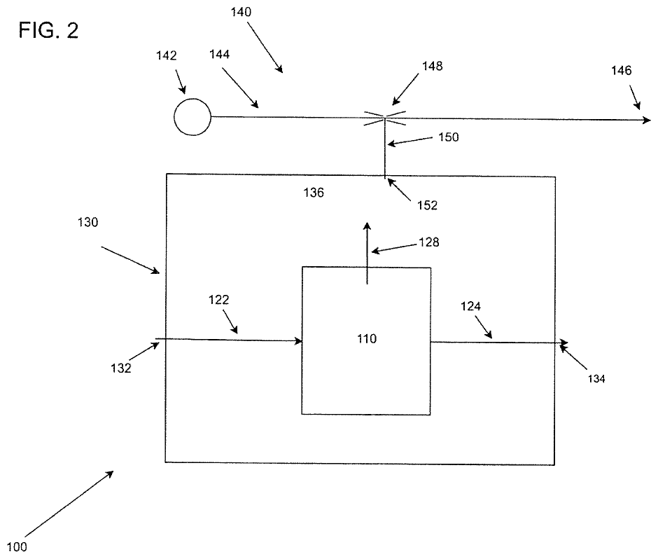

FIG. 2 shows a method and first wastewater treatment apparatus including an anodic oxidation chamber with extraction and expulsion of the waste gases according to a second embodiment of the present invention; and

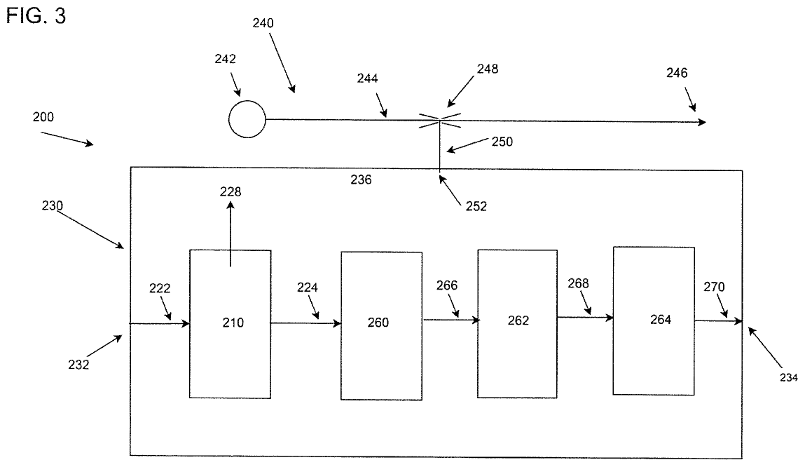

FIG. 3 shows a method and second wastewater treatment apparatus according to a third embodiment of the present invention.

FIG. 1 shows an anodic oxidation subsystem 10 that can be part of a wastewater treatment apparatus. The anodic oxidation subsystem 10 includes an anodic oxidation chamber 12 containing an anodic oxidation cell 17 having an anode 14, preferably a boron doped diamond, and a cathode 16. The anodic oxidation chamber 12 may be any size suitable for the anode oxidation cell 17.

The chamber 12 has an inlet or entry port 18 for wastewater, and an outlet or exit port 20 for treated wastewater.

The anodic oxidation cell 17 may be physically distinct, or may be defined as the area around the anode 14 and cathode 16 providing the treatment.

The anodic oxidation chamber 12 may comprise a number of anodic oxidation cells formed from a number of distinct electrodes, or formed by the sharing of a number of electrodes in a manner known in the art, and generally forming a series of inter-electrode pathways which could allow the passage of a stream therethrough in either a serpentine direction or a parallel direction, or a combination of both.

The anodic oxidation chamber 12 may be a closed chamber, or it may be open, or have one or more openings or vents towards the top, to allow the electrode gases to pass out of the wastewater being treated.

The subsystem 10 has a subsystem feed conduit 22 to bring a clinical analyser wastewater stream 22 to be treated to the entry port 18 of the anodic oxidation chamber 12, and a subsystem outlet conduit 24 to take a post-chamber treated water stream 24 from the chamber 12 through the exit port 20. The wastewater may leave the anodic oxidation chamber 12 under pressure, either residual pressure from the feed conduit 22 if the anodic oxidation chamber 12 is closed, or if the top of the chamber 12 is open, then via an overflow in the wall of the anodic oxidation chamber 12, or a pump sited either within the anodic oxidation chamber 12 or in the outlet conduit 24.

An optional recirculation conduit 26 is shown. This allows repeated treatment of the wastewater to increase the amount of treatment it receives and further reduce the concentrations of azide ions and/or organic molecules in the wastewater. The recirculation may be for all, part or none of the flow in the outlet conduit 24 at any instant, and may be controlled based on readings from sensors (not shown) in either the outlet conduit or elsewhere in the wastewater treatment apparatus.

When a voltage is applied to the electrodes 14, 16 a current is passed through the wastewater. Azide ions are attracted to the anode 14, and at the anode 14 form nitrogen, or react with hydrogen ions generated at the anode 14 to form ammonia. Oxidising species, such as peroxide radicals, are generated at the interface between the anode 14 and the wastewater, and these react with the organic molecules in the wastewater to form smaller organic molecules, or eventually carbon dioxide and water. If the organic molecules contain nitrogen atoms, then gaseous nitrogen and/or ammonia may be produced. Other electrode reactions may produce oxygen at the anode 14 and hydrogen at the cathode 16. The gases produced in the anodic oxidation cell 17 either pass out of the chamber 12 as a gas stream 28 or are carried downstream where they may later pass out of the wastewater.

FIG. 2 shows a first wastewater treatment apparatus 100, including an anodic oxidation subsystem 110 within a chassis 130. The anodic oxidation subsystem may be the subsystem 10 shown and described in FIG. 1. The chassis includes a wastewater inlet port 132, from which subsystem feed conduit 122 carries the wastewater to the anodic oxidation chamber, and a treated wastewater outlet port 134 connected to the anodic oxidation subsystem by a subsystem outlet conduit 124. Gasses 128 generated in the anodic oxidation subsystem 110 pass into the chassis 130 and will accumulate in the headspace 136 of the chassis 130.

The first wastewater treatment apparatus 100 further includes a gas extraction subsystem 140. A fan or pump 142 extracts air from the laboratory where the wastewater treatment apparatus 100 is located, and passes it down an air conduit 144 to an air exit point 146 also located within the laboratory. In the air conduit 144 is an ejector 148. Ejectors are known in the art and the passage of a fluid through the ejector causes a low pressure area which is able to draw another fluid into the ejector, the combined fluids then passing out of the ejector. Ejector 148 causes a suction on a gas extraction conduit 150 connected to a port 152 in the chassis 130. Operation of the fan or pump 142 causes the gas in the headspace 136 of the chassis 130 to be drawn into the flow of air in the ejector 148 and for it to be diluted and passed out of the apparatus 100 into the laboratory at concentrations that are safe to the operators.

FIG. 3 shows a second wastewater treatment apparatus 200 including an anodic oxidation subsystem 210 within a chassis 230. The second wastewater treatment apparatus 200 shares many of the components with the first wastewater treatment apparatus 100 so uses numbering of +100 to represent like components and features.

The second wastewater treatment apparatus 200 further includes a UV disinfection subsystem 260 fed by with the partially treated wastewater from the anodic oxidation subsystem 210 via conduit 224; a filtration subsystem 262 fed by with the partially treated wastewater from the UV disinfection subsystem 260 via conduit 266; and a pH adjustment subsystem 264 fed by with the partially treated wastewater from the filtration subsystem 266 via conduit 268, the outlet of which is passed to the treated wastewater outlet port 234 via conduit 270.

Recirculation of partially treated wastewater from within or after any subsystem to or before any upstream subsystem may be enacted in any means known in the art via conduits not shown.

### EXAMPLE

Apparatus as described in the FIG. 3 using the subsystem 10 and chamber 12 of FIG. 1 was operated with a synthetic wastewater of pH 9.0. Azide was added to the wastewater and passed through the anodic oxidation subsystem containing an anodic oxidation cell having a double sided boron doped diamond anode bordered by a stainless steel cathode on either side of the anode, with a 2 mm gap between the anode and cathodes through which the wastewater was passed.

With no power there was no change in the concentration of azide ion through the anodic oxidation subsystem. When power was applied to the anodic oxidation cell a concentration of azide ions of 161 ppm before the anodic oxidation cell was reduced to 120 ppm after the processing by the anodic oxidation cell.

A second wastewater stream having an azide ion concentration of 1.7 ppm was run through the same apparatus, and the concentration of azide ion was reduced to 1.2 ppm on passage through the powered anodic oxidation cell.

A third wastewater stream having an azide ion concentration of 200 ppm was passed into the same apparatus with complete recirculation of the treated water back to prior to the anodic oxidation cell as shown in FIG. 1. The concentration of azide ion decreased with time, and after 120 minutes no azide ion was detectable in the wastewater at a limit of detection of 100 ppb.

1. A method of treating a clinical analyser wastewater stream containing a first concentration of azide ions in solution, comprising at least the step of:
passing the clinical analyser wastewater stream through an anodic oxidation chamber having one or more anodic oxidation cells to provide a post-chamber treated water stream, said treated water stream having a second concentration of azide ions in solution that is less than the first concentration of azide ions in solution.

2. The method of claim 1 wherein anodic oxidation chamber has an anodic oxidation cell having an anode, and said anode includes boron doped diamond.

3. The method of claim 1 wherein the clinical analyser wastewater stream further has a first concentration of one or more organic molecules, and wherein the treated water stream has a second concentration of the same one or more organic molecules less than the first concentration of one or more organic molecules.

4. The method of claim 3 wherein the clinical analyser wastewater stream further has a first total concentration of one or more organic molecules, and wherein the treated water stream has a second total concentration of the same one or more organic molecules less than the first total concentration of one or more organic molecules.

5. The method of claim 1 wherein all or part of the treated water stream is recirculated through the anodic oxidation chamber and re-treated.

6. The method of claim 1 wherein the second concentration of azide in the treated water stream is less than 100 ppb.

7. The method of claim 1 wherein the anodic oxidation chamber is part of a wastewater treatment apparatus.

8. The method of claim 1 further comprising the step of venting any gases generated by the anodic oxidation chamber.

9. The method of claim 8 wherein the venting of generated gases comprises at least the steps of venting and diluting said gases from the anodic oxidation chamber.

10. The method of claim 1 further comprising the step of treating the clinical analyser wastewater stream with UV irradiation.

11. The method of claim 1 further comprising the step of filtering the clinical analyser wastewater stream.

12. The method of claim 1 further comprising the step of adjusting the pH of the clinical analyser wastewater stream.

13. The method of claim 1 comprising at least the steps of:
passing the clinical analyser wastewater stream through an anodic oxidation chamber having one or more cells to provide a post-chamber treated water stream, said treated water stream having a second concentration of azide ions in solution that is less than the first concentration of azide ions in solution;
venting and diluting any gases generated by the anodic oxidation chamber;
treating the clinical analyser wastewater stream with UV irradiation;
filtering the clinical analyser wastewater stream; and
adjusting the pH of the clinical analyser wastewater stream.

14. A clinical analyser treatment apparatus for treating a clinical analyser wastewater stream, comprising an anodic oxidation chamber having one or more anodic oxidation cells able to reduce the concentration of azide ions in the wastewater stream.

15. The clinical analyser treatment apparatus as claimed in claim 14, configured to reduce the concentration of azide ions in the wastewater stream to less than 100 ppb.

16. The clinical analyser treatment apparatus as claimed in claim 14 comprising an anodic oxidation chamber able to reduce the total concentration of organic molecules in the wastewater stream.

17. The clinical analyser treatment apparatus as claimed in claim 14 wherein the anodic oxidation chamber is part of an anodic oxidation subsystem,

18. The clinical analyser treatment apparatus as claimed in claim 14 comprising an anodic oxidation subsystem, a UV disinfection subsystem, a filtration subsystem and a pH adjustment subsystem.

19. The clinical analyser treatment apparatus as claimed in claim 14 further comprising a gas extraction subsystem.
